(19) United States
(12) Patent Application Publication
(10) Pub. No.: US 2009/0142561 A1
(43) Pub. Date: Jun. 4, 2009

(54) Antireflection laminated body

(75) Inventors: Yiwen Zhang, Tokyo (JP); Koichi Ohata, Tokyo (JP); Eiichi Higashikawa, Tokyo (JP)

Correspondence Address: SQUIRE, SANDERS & DEMPSEY L.L.P., 1 MARITIME PLAZA, SUITE 300, SAN FRANCISCO, CA, 94111, US

(73) Assignee: Toppan Printing Co., Ltd., Tokyo (JP)

(21) Appl. No.: 11/999,626

(22) Filed: Dec. 4, 2007

(51) Int. Cl. B32B 7/02

(52) U.S. Cl. 428/212

(57) ABSTRACT

One embodiment of the present invention is an antireflection laminated body having a transparent substrate, a lower layer of low refractive index layer including a low refractive index particle, and an upper layer of low refractive index layer without a particle. In addition, in another embodiment of the present invention, the refractive index of the lower layer of low refractive index layer is 1.28-1.42, and the refractive index of the upper layer of low refractive index layer is 1.38-1.46.

### BACKGROUND OF THE INVENTION

1. Field of the Invention

The present invention is related to an antireflection laminated body used in a front surface of display devices such as a liquid crystal display, a CRT display, a projection display, a plasma display and an EL display.

2. Description of the Related Art

A display is generally used in a place where an outside light comes, both inside the room and outside the room. This incident light such as the outside light is reflected at a surface of a display, thereby the reflected image is mixed with a displayed image. Therefore quality of a display image is reduced. Therefore, it is necessary for a front surface of a display to have an antireflection function.

In an antireflection laminated body used in a front surface of a liquid crystal display, a technology is proposed. That is, a low refractive index layer is provided on a front surface of a display, thereby the display has an antireflection function. In this case, a low refractive index layer is often formed by dispersing a low refractive index particle in a binder matrix.

In an antireflection laminated body having a low refractive index layer having a binder matrix including a low refractive index particle wherein the low refractive index is in front surface of the body, a fine rugged structure is formed in the surface of the low refractive index layer because of the low refractive index particle.

Here, when the surface of the low refractive index layer having the fine rugged structure is rubbed by a steel wool, a convex part of the rugged structure is chipped off, thereby abrasion resistant property is reduced.
[patent document 1] JP-A-2005-283611

### SUMMARY OF THE INVENTION

The present invention provides an antireflection laminated body having a low refractive index layer of which surface is superior in abrasion resistant property. One embodiment of the present invention is an antireflection laminated body having a transparent substrate, a lower layer of low refractive index including a low refractive index particle, and an upper layer of low refractive index without a particle.

### BRIEF DESCRIPTION OF DRAWINGS

FIG. 1 is a cross sectional view of an antireflection laminated body of an embodiment of the present invention.

FIG. 2 is a cross sectional view of an antireflection laminated body of another embodiment of the present invention.

FIG. 3 is a cross sectional view of an antireflection laminated body of another embodiment of the present invention.

FIG. 4 is shows a transmission type liquid crystal display having an antireflection laminated body of an embodiment of the present invention.

In these drawings, 1 is an antireflection laminated body; 11 is a transparent substrate; 12 is a lower layer of low refractive index; 12A is a low refractive index particle; 13 is a upper layer of low refractive index; 14 is a hard coat layer; 15 is a high refractive index layer; 15A is a conductive particle; 2 is a polarizing plate; 21 is a transparent substrate; 23 is a polarizing layer; 3 is a liquid crystal cell; 4 is a polarizing plate; 41 a transparent substrate; 42 is a transparent substrate; 43 is a polarizing layer; and 5 is a backlight unit.

### DESCRIPTION OF THE PREFERRED EMBODIMENTS

Hereinafter, an antireflection laminated body of the present invention is described.

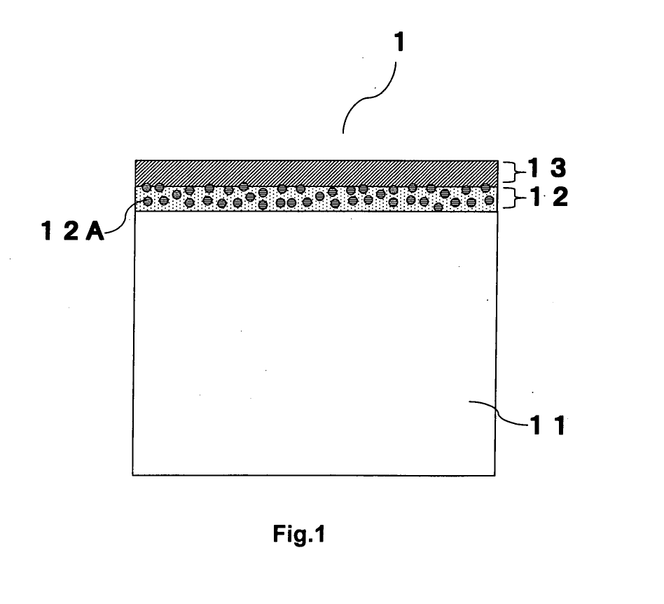

FIG. 1 shows a cross sectional view of an antireflection laminated body of an embodiment of present invention. The antireflection laminated body shown in FIG. 1 has a transparent substrate (11), a lower layer of low refractive index (12) and an upper layer of low refractive index (13), in this order. In the present invention, the feature is that a low refractive index layer has a laminated configuration including the lower layer of low refractive index and the upper layer of low refractive index. In this embodiment, the lower layer of low refractive index includes a low refractive index particle and the upper layer of low refractive index does not include a particle.

In this embodiment, the lower layer of low refractive index includes the low refractive index particle (12A). The upper layer of low refractive index does not include the low refractive index particle and has a binder matrix.

The use of the low refractive index particle for the lower layer of low refractive index can allow the lower layer of low refractive index to have low refractive index. However, the use of the low refractive index particle can allow a surface of the lower layer of low refractive index to have a rugged structure. Therefore, if the surface of the lower layer of low refractive index is the most outer surface, the rugged structure of the surface of the lower layer of low refractive index can allow a convex part of the surface to be preferentially chipped off, thereby the abrasion resistant property is lowered.

In the present invention, since the upper layer of low refractive index without a particle is provided on the lower layer of low refractive index having the rugged structure on its surface, the rugged structure of the surface of the lower layer of low refractive index can be flatten to obtain the low refractive index layer of which surface roughness is very small. Therefore, since the rugged structure of its surface is flattened, the abrasion resistant property of the low refractive index layer of the laminated structure including the lower layer of low refractive index and the upper layer of low refractive index is improved.

A particle which has a void inside itself can be preferable used for the low refractive index particle used for the lower layer of low refractive index. In the particle having a void inside itself, since refractive index of the void can be same as the refractive index of air (about 1), the particle's refractive index can be very low. However, since the particle has the void inside itself, the particle's strength is low. Therefore, since the lower layer of low refractive index includes the low refractive index particle having the void inside itself, the lower layer of low refractive index does not have sufficient strength. In the antireflection laminated body of the present invention's structure, since the upper layer of low refractive index does not have a low refractive index particle with a void inside itself, strength of the surface of the low refractive index layer can be increased to improve the abrasion resistant property.

In this embodiment, it is desirable that the refractive index of the lower layer of low refractive index be 1.28-1.42. When the refractive index of the lower layer of low refractive index is less than 1.28, strength of the lower layer of low refractive index may be lowered. When refractive index of the lower layer of low refractive index is more than 1.42, the desirable antireflection performance can not be achieved. On the other hand, it is desirable that refractive index of the upper layer of low refractive index be 1.38-1.46. In a case where refractive index of the upper layer of low refractive index is less than 1.38, since there are only materials which lowers the strength, it is difficult to realize to manufacture an antireflection laminated body. In a case where refractive index of the upper layer of low refractive index is more than 1.46, it is necessary for the upper layer of low refractive index to be very thin in order to achieve sufficient antireflection performance. In such case, the effect of the present invention may not be achieved.

In addition, it is desirable that difference in refractive index between the upper layer of low refractive index and the lower layer of low refractive index is equal to or less than 0.2. In a case where the difference in refractive index is equal to or less than 0.2, the lower layer of low refractive index and the upper layer of low refractive index can be regarded as single layer comprised of a low refractive index layer. In a case where the difference in refractive index is more than 0.2, it is necessary for the film thickness of the upper layer of low refractive index to be very small in order to achieve sufficient antireflection performance. In such case, the effect of the present invention may not be obtained. In addition, since the upper layer of low refractive index does not include a low refractive index particle, the refractive index of the upper layer of low refractive index tends to be high compared with the lower layer of low refractive index. However, the refractive index of the upper layer of low refractive index can be lower than the refractive index of the lower layer of low refractive index.

In the lower layer of low refractive index and the upper layer of low refractive index, the refractive indexes can be determined by a simulation method using spectroscopic spectrum or the Becke line-detecting method (immersion method).

In addition, in the antireflection laminated body of the present invention, it is desirable that an average particle diameter of the low refractive index particle included in the lower layer of low refractive index be 10 nm-150 nm. In a case where the average particle diameter is more than 150 nm, light scatters at the lower layer of low refractive index, according to Rayleigh scattering, thereby the transparent property may be lowered. In addition, in a case where the average particle diameter is less than 10 nm, the particles may aggregate. In addition, the average particle diameter of the low refractive index particle can be measured by the laser diffraction particle size distribution analyzer or the like.

In addition, in the antireflection laminated body of the present invention, it is desirable that arithmetic average roughness of a surface in a side of the lower layer of low refractive index and the upper layer of low refractive index be 2.5 nm or less. When the arithmetic average roughness of the surface in the side of the low refractive index layer is 2.5 nm or less, that is, very flat, an antireflection laminated body having high abrasion resistant property can be obtained while a convex part of a surface is not chipped off.

In addition, in the antireflection laminated body of the present invention, it is desirable that a total of the following optical thicknesses be 100 nm-200 nm:
1. an optical thickness obtained by multiplying the film thickness of the lower layer of low refractive index by the refractive index of the lower layer of low refractive index; and
2. an optical thickness obtained by multiplying the film thickness of the upper layer of low refractive index by the refractive index of the upper layer of low refractive index.

In the antireflection laminated body, the low refractive index layer including the lower layer of low refractive index and the upper layer of low refractive index carries out an antireflection function. When the total of both optical thicknesses is ¼ of a visible light wave length, the antireflection performance can be maximally realized in a visible light range. In a case where the total of both optical thicknesses is less than 100 nm, the antireflection laminated body having an insufficient antireflection performance is obtained. In addition, in a case where the total of both optical thicknesses is more than 200 nm, the antireflection laminated body having an insufficient antireflection performance is obtained.

In addition, in the antireflection laminated body of the present invention, it is desirable that a value obtained by dividing the film thickness of the upper layer of low refractive index by the film thickness of the lower layer of low refractive index be 0.2-1.5. In a case where the value is less than 0.2, the upper layer of low refractive index does not have enough film thickness to flatten the rugged structure of the surface of the lower layer of low refractive index, thereby the antireflection laminated body does not have sufficient abrasion resistant property. On the other hand, in a case where the value is more than 1.5, the refractive index of the whole low refractive index layer is increased, therefore the antireflection laminated body can not carry out a sufficient antireflection function.

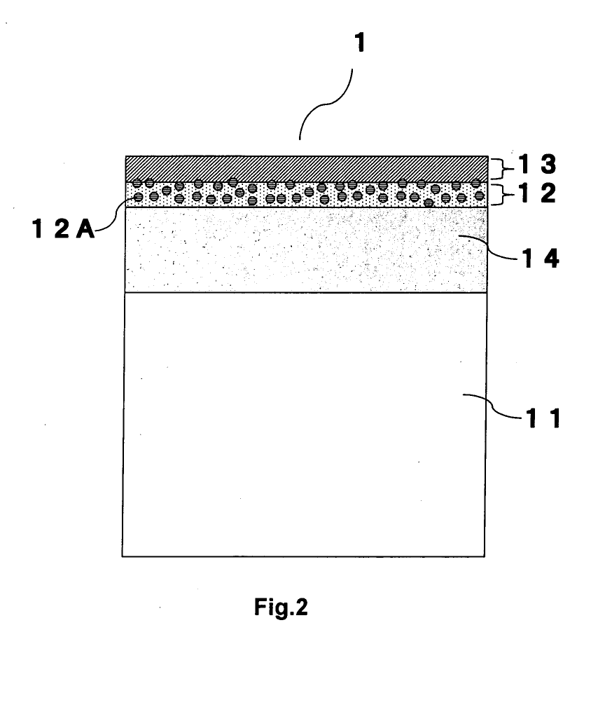

FIG. 2 shows a cross sectional view of another embodiment of an antireflection laminated body of the present invention. The antireflection laminated body (1) shown in FIG. 2 has a transparent substrate (11), a hard coat layer (14), a lower layer of low refractive index (12) and an upper layer of low refractive index (13), in this order. The hard coat layer is cured by irradiating an ionizing radiation-curable material with an ionizing radiation and the hard coat layer can provide a hard coat performance on the surface of the antireflection laminated body. When the transparent substrate is a film or a sheet made of an organic polymer, the hard coat layer is provided on the antireflection laminated body. The antireflection laminated body can have a sufficient surface hardness by providing the hard coat layer on the transparent substrate.

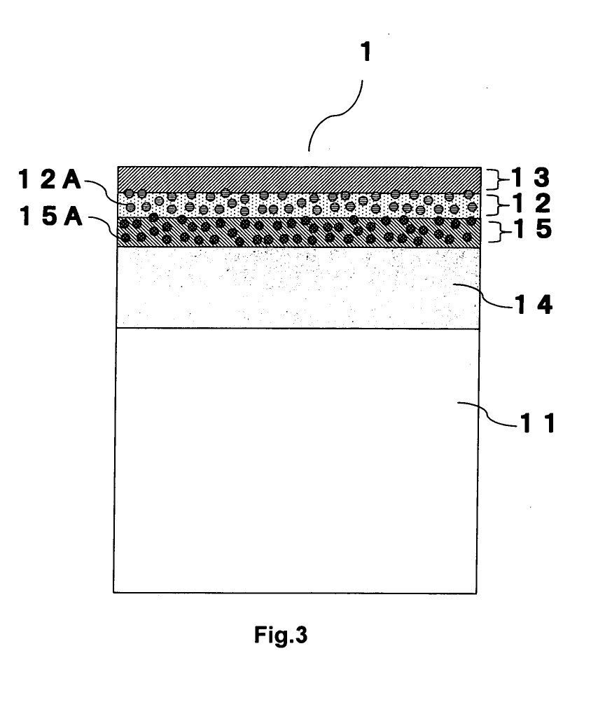

FIG. 3 shows another embodiment of an antireflection laminated body of the present invention. An antireflection laminated body (1) of the present invention shown in FIG. 3 has a transparent substrate (11), a hard coat layer (14), a high refractive index layer (15) including a conductive particle, a lower layer of low refractive index (12) and an upper layer of low refractive index (13), in this order. The conductive high refractive index layer including a conductive particle is provided to the antireflection laminated body, thereby the attaching of a dust or the like on a surface of the antireflection laminated body due to electrostatic charge can be prevented. In this embodiment, the high refractive index layer (15) has a binder matrix including a conductive particle (15A).

In this embodiment, it is desirable that the average particle diameter of the conductive particle be 5 nm-150 nm. In a case where the average particle diameter is more than 150 nm, light is scattered at the lower layer of low refractive index according to Rayleigh scattering, thereby the antireflection laminated body looks whitened and the transparency is reduced. On the other hand, in a case where the average particle diameter is less than 5 nm, there may be a problem that conductivity can not sufficiently obtained or the particles aggregate. In addition, the average particle diameter of the conductive particle can be measured by the laser diffraction particle size distribution analyzer.

In addition, it is desirable that an optical thickness obtained by multiplying a film thickness of the high refractive index layer by a refractive index of the high refractive index layer be 100 nm-400 nm. In a case where the optical thickness is such a value, the conductivity becomes high and low reflection performance can be improved in combination with the low refractive index layer. In a case where the optical thickness of the high refractive index layer is less than 100 nm, the conductivity may be reduced. On the other hand, in a case where the optical thickness of the high refractive index layer is more than 400 nm, the characteristics of reflectance are lowered and further color unevenness may easily occur.

Further, it is desirable that difference in refractive index between a transparent substrate and a hard coat layer be 0.1 or less, and difference in refractive index between a hard coat layer and a high refractive index layer be 0.1 or less. In a case where the respective differences in refractive index are within the desired ranges, an interference stripe, a color unevenness due to interference or the like can be controlled.

In addition, an antireflection laminated body of the present invention is not limited to the configurations shown in FIGS. 1-3. For example, in FIG. 2, a conductive layer can be provided between the hard coat layer and the transparent substrate. In addition, further, an infrared absorbing layer having an infrared absorbing performance, an ultraviolet absorbing layer having an ultraviolet absorbing performance or the like can be provided in the antireflection laminated body. In addition, to improve adhesion property between some kinds of layers, a primer layer, an adhesion layer and the like can be provided between some layers.

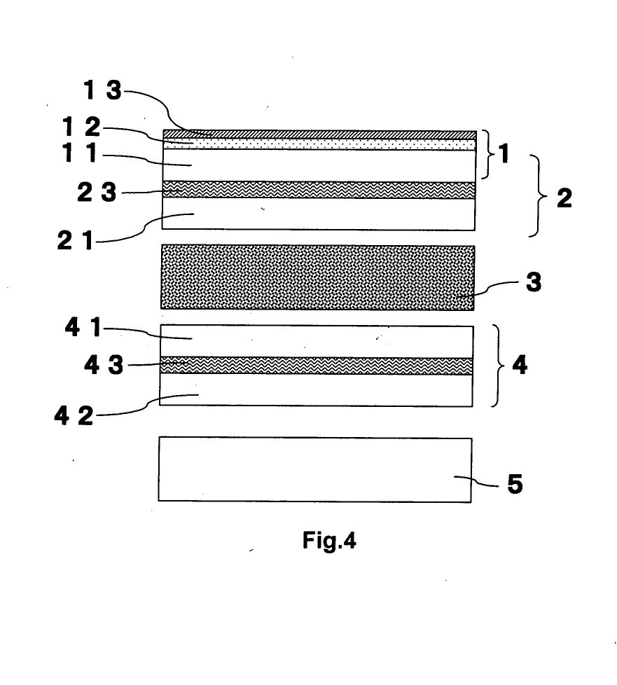

FIG. 4 is a cross-sectional view showing a transmission type liquid crystal display with the use of an antireflection laminated body of an embodiment of the present invention. A transmission type liquid crystal display shown in FIG. 4 has a backlight unit (5), a polarization plate (4), a liquid crystal cell (3), a polarization plate (2) and an antireflection laminated body (1) in this order. In this embodiment, an antireflection laminated body (1) side is an observer side, that is, a front surface of a display.

A backlight unit (5) has a light source and a light diffusing plate. In a liquid crystal cell, an electrode is provided on a transparent substrate in one side, an electrode and a color filter are provided on a transparent substrate in another side and a liquid crystal is encapsulated between both of the electrodes. In polarization plates sandwiching a liquid crystal cell (3), polarization layers (23, 43) are between transparent substrates (11, 21, 41 and 42).

In FIG. 4, polarizing layer (23) is formed on a surface of transparent substrate (ii), wherein a low refractive index layer is formed on another surface of transparent substrate (11) of an antireflection laminated body (1). That is, transparent substrate (ii) is a transparent substrate of an antireflection laminated body and is a transparent substrate of polarizing plate (2).

In the present invention, a polarizing plate can be prepared by providing a polarizing layer and a transparent substrate, in this order, on a surface of a transparent substrate wherein a lower layer of low refractive index and an upper layer of low refractive index is formed on another surface of a transparent substrate.

Hereinafter, a method for manufacturing an antireflection laminated body of the present invention is described. A film or a sheet made of various organic polymers can be used for a transparent substrate of an antireflection laminated body of the present invention. For example, a substrate which is usually used for an optical member of a display or the like can be used for a transparent substrate for the present invention. In view of optical characteristics such as transparency and refractive index of light, and other various characteristics such as impact resistance, heat resistance and decay resistance, the following materials are used: poly olefinic systems such as polyethylene and polypropylene, poly ester such as polyethylene terephthalate and polyethylenenaphthalate, cellulose type such as triacetylcellulose, diacetyl cellulose and cellophane, poly amide systems such as 6-nylon and 6,6-nylon, acrylic system such as polymethyl methacrylate, and organic polymers such as polystyrene, polyvinyl chloride, polyimide, polyvinyl alcohol, polycarbonate and ethylene vinyl alcohol. Particularly, polyethylene terephthalate, triacetylcellulose, polycarbonate and polymethyl methacrylate are preferable. Among them, triacetylcellulose is preferably used for a liquid crystal display since triacetylcellulose has a low birefringence and a good transparency.

Further, a transparent substrate can have a function by adding well-known additives to these organic polymers. Examples of the additives include an antistatic agent, an ultraviolet absorber, an infrared absorber, a plasticizing agent, a lubricant, a coloring agent, an antioxidant and a fire retardant. In addition, a transparent substrate may be made of mixture including two or more kinds of the above-mentioned materials or may be made of a polymer comprised of two or more kinds of the above-mentioned materials. A transparent substrate may be a laminated body including a plurality of layers. A stretched polyvinyl alcohol (PVA) with iodine added thereto can be used for a polarizing layer which is provided on a surface of a transparent substrate, wherein a lower layer of low refractive index and an upper layer of low refractive index are provided on another surface of a transparent substrate.

Hereinafter, a method for manufacturing a lower layer of low refractive index in the present invention is described. The lower layer of low refractive index of the present invention can be formed by a wet film forming method, that is, the lower layer of low refractive index can be formed by applying a coating liquid including a low refractive index particle and a binder matrix forming material. Examples of application methods to be used in this case include a method using a roll coater, a reverse roll coating machine, a gravure coater, a micro gravure coater, a knife coater, a bar coating machine, a die coating machine or a dip coater.

A low refractive index particle made of a low refractive index material such as LiF, MgF, 3NaF.AlF or AlF (both: refractive index 1.4), or Na₃AlF₆ (cryolite: refractive index 1.33) can be used for a low refractive index particle in the present invention. In addition, a particle having a void inside itself can be preferably used. In the particle having a void inside itself, since refractive index of the void can be same as the refractive index of air (about 1), the particle's refractive index can be very low. In particular, low refractive index silica particle having a void inside itself can be used.

A particle having a void inside itself can be a low refractive index particle having very low refractive index, however strength of the particle is weak since the particle has a void inside itself. Therefore, there was a problem that a low refractive index layer including a low refractive index particle having a void inside itself did not have a sufficient strength. In the present invention, an upper layer of low refractive index, without a particle, of which film strength is strong, is formed on a lower layer of low refractive index including a low refractive index particle having a void inside itself, of which film thickness is weak. Therefore, in the low refractive index layer as a whole, the film thickness is increased and the abrasion resistant property is improved. That is, in an antireflection laminated body of the present invention, if a particle having a void inside itself is used for a lower layer of low refractive index, greater effect is obtained.

Hydrolyzate of silicon alkoxide can be used for a binder matrix forming material. Further, hydrolyzate of silicon alkoxide shown by a general formula (1) RₓSi(OR)₄₋ₓ (R: alkyl group, x is an integer number (0≦x≦3)) can be used.

Examples silicon alkoxides shown by the general formula (1) include tetramethoxy silane, tetraethoxysilane, tetra-iso-propoxy silane, tetra-n-propoxy silane, tetra-n-butoxy silane, tetra-sec-butoxy silane, tetra-tert-butoxy silane, tetrapenta ethoxy silane, tetrapenta-iso-propoxy silane, tetrapenta-n-proxy silane, tetrapenta-n-butoxy silane, tetrapenta-sec-butoxy silane, tetrapenta-tert-butoxy silane, carbinyl trimethoxysilane, methyltriethoxysilane, carbinyl tri propoxy silane, carbinyl tri butoxy silane, dimethyl dimethoxy silane, dimethyldiethoxysilane, dimethyl ethoxy silane, dimethyl methoxy silane, dimethyl propoxy silane, dimethyl butoxy silane, carbinyl dimethoxy silane, carbinyl diethoxy silane and hexyl trimethoxysilane. Hydrolyzate of silicon alkoxide can be any materials obtained by using metalalkoxide expressed by the general formula (1) as a starting material. An example is a material obtained by hydrolyzing by hydrochloric acid.

In addition, an ionizing radiation-curable material can be used for a binder matrix forming material. Polyfunctional acrylate such as polyfunctional urethane acrylate can be used for an ionizing radiation-curable material. In addition to this material, polyether resin, polyester resin, epoxy resin, alkyd resin, spiro acetal resin, poly polybutadiene-type resin and polythiol polyene resin having a functional group of acrylate system can be used for an ionizing radiation-curable material.

In a case where hydrolyzate of silicon alkoxide is used for a binder matrix forming material, a binder matrix and a lower layer of low refractive index can be formed by the following processes: a coated film is formed on a transparent substrate by applying a coating liquid including hydrolyzate of silicon alkoxide and a low refractive index particle; and the coated film is dried/heated and the reaction of dehydration and condensation of silicon alkoxide is performed. In addition, in a case where an ionizing radiation-curable material is used for a binder matrix forming material, a binder matrix and a lower layer of low refractive index can be formed by the following processes: a coated film is formed on a transparent substrate by applying a coating liquid including an ionizing radiation-curable material and a low refractive index particle; and the coated film is dried as needed, thereafter an ionizing radiation-curable material is hardened by irradiating the ionizing radiation-curable material with the ionizing radiation such as the ultra violet ray or the electron beam.

A coating liquid can include a solvent or various additives as needed. A solvent is selected, while suitability for coating is considered, among aromatic hydrocarbons such as toluene, xylene, cyclohexane and cyclohexylbenzene, hydrocarbon such as n-hexane, ether such as dibutyl ether, dimethoxymethane, dimethoxyethane, diethoxyethane, propylene oxide, dioxan, dioxolane, trioxane, tetrahydrofuran, anisole and phenetole, ketones such as methyl isobutyl ketone, methyl butyl ketone, acetone, methyl ethyl ketone, diethyl ketone, dipropyl ketone, di-isobutyl ketone, cyclopentanone, cyclohexanone and methylcyclohexanone, Ester such as ethyl formate, propyl formate, formic acid n-pentyl, methyl acetate, ethyl acetate, methyl propionate, methyl propionate, acetic acid n-pentyl and γ-butyrolactone, cellosolve such as methyl cellosolve, cellosolve, butylcellosolve and cellosolve acetate, alcohols such as methanol, ethanol and isopropanol, and water. In addition, additives such as a surfactant, an antistatic agent, a refraction index-adjusting agent, an antifouling agent, a water repellent agent, an adhesiveness-improving agent and a curing agent can be added to the coating liquid.

In addition, in a case where an ionizing radiation-curable material is used for a binder matrix and a lower layer of low refractive index is formed by irradiating with an ultra violet ray, a photopolymerization initiator is added to a coating liquid. Examples of photopolymerization initiators include acetophenone, benzoin, benzophenone, phosphine oxide, ketal, anthra quinines and thioxanthone.

A lower layer of low refractive index is formed by the above-mentioned method.

Next, a method for manufacturing an upper layer of low refractive index of the present invention is described.

The upper layer of low refractive index of the present invention can be formed by a wet film forming method. That is, the upper layer of low refractive index can be formed by applying a coating liquid including a low refractive index particle and a binder matrix forming material. Examples of application methods used in this case include a method using a roll coater, a reverse roll coating machine, a gravure coater, a micro gravure coater, a knife coater, a bar coating machine, a die coating machine or a dip coater.

Hydrolyzate of silicon alkoxide can be used for a binder matrix forming material. Further, hydrolyzate of silicon alkoxide shown by a general formula (1) RₓSi(OR)₄₋ₓ (R: alkyl group, x is an integer number (0≦x≦3)) can be used.

Examples silicon alkoxides shown by the general formula (1) include tetramethoxy silane, tetraethoxysilane, tetra-iso-propoxy silane, tetra-n-propoxy silane, tetra-n-butoxy silane, tetra-sec-butoxy silane, tetra-tert-butoxy silane, tetrapenta ethoxy silane, tetrapenta-iso-propoxy silane, tetrapenta-n-proxy silane, tetrapenta-n-butoxy silane, tetrapenta-sec-butoxy silane, tetraperita-tert-butoxy silane, carbinyl trimethoxysilane, methyltriethoxysilane, carbinyl tri propoxy silane, carbinyl tri butoxy silane, dimethyl dimethoxy silane, dimethyldiethoxysilane, dimethyl ethoxy silane, dimethyl methoxy silane, dimethyl propoxy silane, dimethyl butoxy silane, carbinyl dimethoxy silane, carbinyl diethoxy silane and hexyl trimethoxysilane. Hydrolyzate of silicon alkoxide can be any materials obtained by using metalalkoxide expressed by the general formula (1) as a starting material. An example is a material obtained by hydrolyzing by hydrochloric acid.

Further, it is desirable that a binder matrix forming material includes hydrolyzate of fluorine system silicon alkoxide shown by a general formula (2) R′_{Z}Si(OR)_{4-z} (R′: a nonresponsiveness functional group having fluoroalkyl group or fluoroalkylene oxide group, Z is an integer number (1≦x≦3)), besides silicon alkoxides shown by the general formula (1). The use of hydrolyzate of fluorine system silicon alkoxide shown by the general formula (2) can allow the upper layer of low refractive index to have an antifouling property and to reduce the refractive index of the upper layer of low refractive index. Examples of fluorine system silicon alkoxide shown by the general formula (2) include octadecyl trimethoxysilane, 1H, 1H, 2H, 2H-perfluoro octyl trimethoxysilane.

In addition, it is desirable that the molar ratio of silicon alkoxides shown by the general formula (1)/fluorine system silicon alkoxide shown by the general formula (2) be 1.0/0.01-1.0/0.2.

In addition, an ionizing radiation-curable material can be used for a binder matrix forming material. Polyfunctional acrylate such as polyfunctional urethane acrylate can be used for an ionizing radiation-curable material. In addition to this material, polyether resin, polyester resin, epoxy resin, alkyd resin, spiro acetal resin, poly polybutadiene-type resin and polythiol polyene resin having a functional group of acrylate system can be used for an ionizing radiation-curable material.

In an ionizing radiation-curable material, it is desirable that a fluorine system material be also included in an ionizing radiation-curable material in order to provide an antifouling property to the upper layer of low refractive index and in order to reduce the refractive index of the upper layer of low refractive index.

In a case where hydrolyzate of silicon alkoxide is used for a binder matrix forming material, a binder matrix and an upper layer of low refractive index can be formed by the following processes: a coated film is formed on a transparent substrate by applying a coating liquid including hydrolyzate of silicon alkoxide; and the coated film is dried/heated and the reaction of dehydration and condensation of silicon alkoxide is performed. In addition, in a case where an ionizing radiation-curable material is used for a binder matrix forming material, a binder matrix and an upper layer of low refractive index can be formed by the following processes: a coated film is formed on a transparent substrate by applying a coating liquid including an ionizing radiation-curable material; and the coated film is dried as needed, thereafter an ionizing radiation-curable material is hardened by irradiating the ionizing radiation-curable material with the ionizing radiation such as the ultra violet ray or the electron beam.

A coating liquid can include a solvent or various additives as needed. A solvent is selected, while suitability for coating is considered, among aromatic hydrocarbons such as toluene, xylene, cyclohexane and cyclohexylbenzene, hydrocarbon such as n-hexane, ether such as dibutyl ether, dimethoxymethane, dimethoxyethane, diethoxyethane, propylene oxide, dioxan, dioxolane, trioxane, tetrahydrofuran, anisole and phenetole, ketones such as methyl isobutyl ketone, methyl butyl ketone, acetone, methyl ethyl ketone, diethyl ketone, dipropyl ketone, di-isobutyl ketone, cyclopentanone, cyclohexanone and methylcyclohexanone, Ester such as ethyl formate, propyl formate, formic acid n-pentyl, methyl acetate, ethyl acetate, methyl propionate, methyl propionate, acetic acid n-pentyl and γ-butyrolactone, cellosolve such as methyl cellosolve, cellosolve, butylcellosolve and cellosolve acetate, alcohols such as methanol, ethanol and isopropanol, and water. In addition, additives such as a surfactant, an antistatic agent, a refraction index-adjusting agent, an antifouling agent, a water repellent agent, an adhesiveness-improving agent and a curing agent can be added to the coating liquid.

In addition, in a case where an ionizing radiation-curable material is used for a binder matrix and an upper layer of low refractive index is formed by irradiating with an ultra violet ray, a photopolymerization initiator is added to a coating liquid. Examples of photopolymerization initiators include acetophenone, benzoin, benzophenone, phosphine oxide, ketal, anthra quinines and thioxanthone.

An upper layer of low refractive index is formed by the above-mentioned method.

In addition, it is desirable that a binder matrix forming material of the lower layer of low refractive index be the same kind material as a binder matrix forming material of the upper layer of low refractive index. In particular, in a case where silicon alkoxide is used for a binder matrix forming material of the lower layer of low refractive index, silicon alkoxide is preferably used for a binder matrix forming material of the upper layer of low refractive index. In a case where an ionizing radiation-curable material is used for a binder matrix forming material of the lower layer of low refractive index, an ionizing radiation-curable material is preferably used for a binder matrix forming material of the upper layer of low refractive index. When the same kind material is used for a binder matrix forming material of the upper layer of low refractive index and for a binder matrix forming material of the lower layer of low refractive index, adhesion between the lower layer of low refractive index and the upper layer of low refractive index is improved. Therefore, the abrasion resistant property can be further improved.

Next, a method for manufacturing a hard coat layer is described. A hard coat layer can be formed by the following processes: a coated film is formed on a transparent substrate by applying a coating liquid including an ionizing radiation-curable material; the coated film is dried as needed; and thereafter the ionizing radiation-curable material is hardened by irradiating the ionizing radiation-curable material with an ionizing radiation such as an ultra violet ray or an electron beam. Examples of application methods used in this case include a method using a roll coater, a reverse roll coating machine, a gravure coater, a micro gravure coater, a knife coater, a bar coating machine, a die coating machine or a dip coater.

Examples of ionizing radiation-curable materials for forming the hard coat layer include polyfunctional acrylate having 3 or more (meta)acrylyl groups, more preferably 4-20 (meta)acrylyl groups, such as acrylic acid ester, acryl amides, methacrylic acid ester or methacrylic acid amides. In addition, polyfunctional acrylate may be a monomer or an oligomer. Examples of polyfunctional acrylate include trimethylolpropane tri(meta)acrylate, pentaerythritol tri(meta)acrylate, pentaerythritol tetra(meta)acrylate and dipentaerythritol hexa(meta)acrylate.

Polyfunctional urethane acrylate among polyfunctional acrylate is preferably used because, in polyfunctional urethane acrylate, the molecular weight and the molecular structure thereof can be designed and the characteristics of the hard coat layer can be easily balanced. Urethane acrylate can be obtained by reacting polyalcohol with polyisocyanate and hydroxyl-containing(meth)acrylate. In particular, UA-306H, UA-306T and UA-306l (products of KYOEISHA CHEMICAL Co.,LTD.), UV-1700B, UV-6300B, UV-7600B, UV-7605B, UV-7640B and UV-7650B (products of Nippon Synthetic Chemical Industry Co., LTD.), U-4HA, U-6HA, UA-100H, U-6LPA, U-15HA, UA-32P and U-324A (products of Shin-nakamura Chemical Co., LTD.), Ebecryl-1290, Ebecryl-1290K and Ebecryl-5129 (DAICEL-UCB Company LTD.), UN-3220HA, UN-3220HB, UN-3220HC and UN-3220HS (products of Negami Chemical Industrial Co., Ltd.) can be used, but usable products are not limited to them.

Besides these materials, polyether resin, polyester resin, epoxy resin, alkyd resin, spiro acetal resin, poly polybutadiene-type resin and polythiol polyene resin having a functional group of acrylate system can be used as an ionizing radiation-curable material.

In addition, in a case where a coating liquid for forming a hard coat layer is hardened with an ultra violet ray, a photopolymerization initiator is added to the coating liquid for forming the hard coat layer. Any photopolymerization initiator can be used if it generates radicals when it is irradiated with an ultra violet ray. Examples of photopolymerization initiators include acetophenone, benzoin, benzophenone, phosphine oxide, ketal, anthra quinines and thioxanthone. In addition, an additive amount of additives is 0.1-10 part by weight, more preferably 1-7 part by weight, further more preferably 1-5 part by weight, when an amount of an ionizing radiation-curable material is 10-80 part by weight.

A coating liquid for forming a hard coat layer can include a solvent or various additives as needed. A solvent is selected, while suitability for coating is considered, among aromatic hydrocarbons such as toluene, xylene, cyclohexane and cyclohexylbenzene, hydrocarbon such as n-hexane, ether such as dibutyl ether, dimethoxymethane, dimethoxyethane, diethoxyethane, propylene oxide, dioxan, dioxolane, trioxane, tetrahydrofuran, anisole and phenetole, ketones such as methyl isobutyl ketone, methyl butyl ketone, acetone, methyl ethyl ketone, diethyl ketone, dipropyl ketone, di-isobutyl ketone, cyclopentanone, cyclohexanone and methylcyclohexanone, ester such as ethyl formate, propyl formate, formic acid n-pentyl, methyl acetate, ethyl acetate, methyl propionate, methyl propionate, acetic acid n-pentyl and γ-butyrolactone, cellosolve such as methyl cellosolve, cellosolve, butylcellosolve and cellosolve acetate, alcohols such as methanol, ethanol and isopropanol, and water. In addition, additives such as a surfactant, a refraction index-adjusting agent, an adhesiveness-improving agent and a curing agent can be added to the coating liquid.

In addition, thermoplastic resin can be added to the coating liquid in order to control curl of an antireflection laminated body including a hard coat layer. In this way, a hard coat layer is formed.

In addition, before a lower layer of low refractive index or high refractive index layer is formed on a hard coat layer, surface treatments such as acid treatment, alkali treatment, corona treatment and atmospheric pressure glow discharge plasma method can be performed. These surface treatments can further improve adhering property between a hard coat layer and a lower layer of low refractive index (or a high refractive index layer).

In a case where a lower layer of low refractive index or a high refractive index layer is formed on a hard coat layer by using a metalalkoxide such as silicon alkoxide as a binder matrix, it is desirable that alkali treatment be performed before forming a lower layer of low refractive index or a high refractive index layer. Alkali treatment can improve adhering property between a hard coat layer and a low refractive index layer (or a high refractive index layer), thereby the abrasion resistant property of an antireflection laminated body can be further improved.

Next, a conductive high refractive index layer is described. It is desirable that difference in refractive index between a high refractive index layer provided on a hard coat layer and a hard coat layer is 0.04 or less. In a case where difference in refractive index between a high refractive index layer and a hard coat layer is more than 0.04, interference may occur in the obtained antireflection laminated body.

The high refractive index layer in the present invention can be formed by forming a coated film on a transparent substrate by applying a coating liquid including a conductive high refractive index particle and a binder matrix forming material. Examples of application methods used in this case include a method using a roll coater, a reverse roll coating machine, a gravure coater, a micro gravure coater, a knife coater, a bar coating machine, a die coating machine or a dip coater.

Examples of conductive particles include indium oxide, tin oxide, indium oxide-tin oxide (ITO), zinc oxide, zinc oxide-aluminium oxide (AZO), zinc oxide-gallium oxide (GZO), indium oxide-cerium oxide, antimony oxide, antimony oxide-tin oxide (ATO) and tungsten oxide.

Hydrolyzate of silicon alkoxide can be used for a binder matrix forming material. Further, hydrolyzate of silicon alkoxide shown by a general formula (1) RₓSi(OR)₄₋ₓ (R: alkyl group, x is an integer number (0≦x≦3)) can be used.

Examples silicon alkoxides shown by the general formula (1) include tetramethoxy silane, tetraethoxysilane, tetra-iso-propoxy silane, tetra-n-propoxy silane, tetra-n-butoxy silane, tetra-sec-butoxy silane, tetra-tert-butoxy silane, tetrapenta ethoxy silane, tetrapenta-iso-propoxy silane, tetrapenta-n-proxy silane, tetrapenta-n-butoxy silane, tetrapenta-sec-butoxy silane, tetrapenta-tert-butoxy silane, carbinyl trimethoxysilane, methyltriethoxysilane, carbinyl tri propoxy silane, carbinyl tri butoxy silane, dimethyl dimethoxy silane, dimethyldiethoxysilane, dimethyl ethoxy silane, dimethyl methoxy silane, dimethyl propoxy silane, dimethyl butoxy silane, carbinyl dimethoxy silane, carbinyl diethoxy silane and hexyl trimethoxysilane. Hydrolyzate of silicon alkoxide can be any materials obtained by using metalalkoxide expressed by the general formula (1) as a starting material. An example is a material obtained by hydrolyzing by hydrochloric acid.

In addition, an ionizing radiation-curable material can be used for a binder matrix forming material. Polyfunctional acrylate such as polyfunctional urethane acrylate can be used for an ionizing radiation-curable material. In addition to this material, polyether resin, polyester resin, epoxy resin, alkyd resin, spiro acetal resin, poly polybutadiene-type resin and polythiol polyene resin having a functional group of acrylate system can be used for an ionizing radiation-curable material.

In a case where hydrolyzate of silicon alkoxide is used for a binder matrix forming material, a binder matrix and a high refractive index layer can be formed by the following processes: a coated film is formed on a transparent substrate by applying a coating liquid including hydrolyzate of silicon alkoxide and a conductive particle; and the coated film is dried/heated and the reaction of dehydration and condensation of silicon alkoxide is performed. In addition, in a case where an ionizing radiation-curable material is used for a binder matrix forming material, a binder matrix and a high refractive index layer can be formed by the following processes: a coated film is formed on a transparent substrate by applying a coating liquid including an ionizing radiation-curable material and a conductive particle; and the coated film is dried as needed, thereafter an ionizing radiation-curable material is hardened by irradiating the ionizing radiation-curable material with the ionizing radiation such as the ultra violet ray or the electron beam.

A coating liquid can include a solvent or various additives as needed. A solvent can be selected, while suitability for coating is considered, among aromatic hydrocarbons such as toluene, xylene, cyclohexane and cyclohexylbenzene, hydrocarbon such as n-hexane, ether such as dibutyl ether, dimethoxymethane, dimethoxyethane, diethoxyethane, propylene oxide, dioxan, dioxolane, trioxane, tetrahydrofuran, anisole and phenetole, ketones such as methyl isobutyl ketone, methyl butyl ketone, acetone, methyl ethyl ketone, diethyl ketone, dipropyl ketone, di-isobutyl ketone, cyclopentanone, cyclohexanone and methylcyclohexanone, ester such as ethyl formate, propyl formate, formic acid n-pentyl, methyl acetate, ethyl acetate, methyl propionate, methyl propionate, acetic acid n-pentyl and γ-butyrolactone, cellosolve such as methyl cellosolve, cellosolve, butylcellosolve and cellosolve acetate, alcohols such as methanol, ethanol and isopropanol, and water. In addition, additives such as a surfactant, an antistatic agent, a refraction index-adjusting agent, an antifouling agent, a water repellent agent, an adhesiveness-improving agent and a curing agent can be added to the coating liquid.

In addition, in a case where an ionizing radiation-curable material is used for a binder matrix and a high refractive index layer is formed by irradiating with an ultra violet ray, a photopolymerization initiator is added to the coating liquid. Examples of photopolymerization initiators include acetophenone, benzoin, benzophenone, phosphine oxide, ketal, anthra quinines and thioxanthone. A high refractive index layer is formed by the above-mentioned method.

In addition, it is desirable that a binder matrix forming material of the lower layer of low refractive index be the same kind material as a binder matrix forming material of the conductive high refractive index layer. In particular, in a case where silicon alkoxide is used for a binder matrix forming material of the lower layer of low refractive index, silicon alkoxide is preferably used for a binder matrix forming material of the high refractive index. In a case where an ionizing radiation-curable material is used for a binder matrix forming material of the lower layer of low refractive index, an ionizing radiation-curable material is preferably used for a binder matrix forming material of the high refractive index layer. When the same kind material is used for a binder matrix forming material of the conductive high refractive index layer and for a binder matrix forming material of the lower layer of low refractive index, adhesion between the lower layer of low refractive index and the high refractive index layer is improved. Therefore, the abrasion resistant property can be further improved.

In an antireflection laminated body having the above-mentioned structure, the surface of the low refractive index layer is superior in flatness and the laminated body is superior in the abrasion resistant property.

### EXAMPLE

Hereinafter, examples are described.

### (Preparing a Coating Liquid for Forming a Hard Coat Layer)

A coating liquid for forming a hard coat layer was prepared by mixing 80 parts by weight of polyfunctional urethane acrylate (UV1700B, a product of Nippon Synthetic Chemical Industry Co., LTD.) with 5 parts by weight of 1-hydroxycyclohexyl phenyl ketone (a photopolymerization initiator: Irgacure 184 by Ciba Specialty Chemicals)), in 80 parts by weight of methyl isobutyl ketone.

### (Preparing a Coating Liquid for Forming a High Refractive Index Layer)

A liquid including the following materials were prepared: an antimony oxide-tin oxide (ATO) particle (primary particle diameter: 10 nm)/60 parts by weight; and

a silica binder comprised of an oligomer obtained by hydrolyzate of an organosilicon compound comprising tetraethoxysilane/40 parts by weight.

The liquid was diluted by isopropanol so that solid content was 15%.

### (Preparing a Coating Liquid A for Forming a Low Refractive Index Layer)

A mixed liquid including the following materials were prepared: tetramethoxy silane solution/53 parts by weight; and

low refractive index silica particle having an average particle diameter of 60 nm (having a void inside itself)/47 parts by weight.

The mixed liquid of 1 mol with hydrochloric acid (1N) of 7.5 mol was diluted by isopropanol so that solid content was 15%. Thereafter, the diluted liquid was stirred for 1 hour and hydrolyzed to prepare a coating liquid A for forming a low refractive index layer, including a low refractive index particle.

### (Preparing a Coating Liquid B for Forming a Low Refractive Index Layer)

A mixed liquid was prepared by adding heptadecafluoro decyltriusopropoxy silane of 0.03 mol to Tetramethoxy silane solution of 1 mol.

The mixed liquid of 1 mol with hydrochloric acid (1N) of 7.5 mol was diluted by isopropanol so that solid content was 15%. Thereafter, the diluted liquid was stirred for 1 hour and hydrolyzed to prepare a coating liquid B for forming a low refractive index layer, without a low refractive index particle.

### (Preparing a Coating Liquid C for Forming a Low Refractive Index Layer)

A mixed liquid was prepared by adding heptadecafluoro decyltriisopropoxy silane of 0.015 mol to Tetramethoxy silane solution of 1 mol.

Thereafter the following materials were combined as a solution:

a matrix including the mixed liquid of 1 mol and hydrochloric acid (1N) of 7.5 mol/60 parts by weight; and

a low refractive index silica particle having an average particle diameter of 60 nm (having a void inside itself)/40 parts by weight.

Thereafter the solution was diluted by isopropanol, and was stirred for 1 hour and hydrolyzed to prepare a coating liquid C for forming a low refractive index layer, having a low refractive index particle.

### Example 1

Triacetylcellulose film (TDY80UL, a product of FUJIFILM Corporation:thickness 80 μm, refractive index 1.49) was prepared as a transparent substrate. A coating liquid for forming a hard coat layer was applied to the triacetylcellulose film by micro gravure method and was dried for 1 minute using a dryer for sending air of 100° C. Then, a hard coat layer of 5 μm film thickness was formed on the triacetylcellulose film by curing the liquid by UV irradiation (total amount of light: 500 mJ/cm²) using an electrodeless lamp (V valve, Fusion systems Japan KK.). In addition, refractive index of the formed hard coat layer was 1.52.

Alkali treatment was performed for the triacetylcellulose film on which the hard coat layer was formed. In this case, the film was dipped in 1.5 N—NaOH water solution of 50° C. for 2 minutes. After the film has been washed by water, the film was neutralized by dipping it 0.5 weight %—H₂SO₄ water solution at room temperature for 30 seconds. Thereafter the film was washed by water and dried.

Next, the coating liquid for forming the high refractive index layer was applied to the hard coat layer, which the alkali treatment was performed, by a micro gravure method. Then, the liquid was heated and cured for 5 minutes using an oven of 120° C. to form a high refractive index layer of 200 nm film thickness on the hard coat layer. In addition, the refractive index of the formed high refractive index layer was 1.55.

Next, the coating liquid A for forming the low refractive index layer including the low refractive index particle was applied to the high refractive index layer by a micro gravure method. Thereafter, the liquid A was heated and cured using an oven of 120° C. for 5 minutes to form a lower layer of low refractive index of 80 nm film thickness on the high refractive index layer. In addition, the refractive index of the formed lower layer of low refractive index was 1.34.

Next, the coating liquid B for forming the low refractive index layer without a low refractive index particle was applied to the lower layer of low refractive index by a micro gravure method. Thereafter, the liquid B was heated and cured using an oven of 120° C. for 5 minutes to form an upper layer of low refractive index of 20 nm film thickness on the lower layer of low refractive index. In addition, the refractive index of the formed upper layer of low refractive index was 1.42.

In this way, an antireflection laminated body of the present invention was obtained.

### Example 2

By the same method as Example 1, a hard coat layer (film thickness 5 μm, refractive index 1.52) was formed on a triacetylcellulose film (TDY80UL, a product of FUJIFILM Corporation:thickness 80 μm, refractive index 1.49) using the coating liquid for forming the hard coat layer. Further, by the same method as Example 1, alkali treatment of the hard coat layer was performed. Then, by the same method as Example 1, a high refractive index layer (film thickness 200 nm, refractive index 1.55) was formed on a surface of the hard coat layer where alkali treatment was performed, by using the coating liquid for forming the hard coat layer.

Next, the coating liquid A for forming the low refractive index layer including the refractive index particle was applied to the high refractive index layer by a micro gravure method. The liquid A was heated and cured using an oven of 120° C. for 5 minutes to form a lower layer of low refractive index having a film thickness of 60 nm on the high refractive index layer. In addition, the refractive index of the formed lower layer of low refractive index was 1.34.

Next, the coating liquid B for forming the low refractive index layer without the refractive index particle was applied to the lower layer of low refractive index by a micro gravure method. The liquid B was heated and cured using an oven of 120° C. for 5 minutes to form an upper layer of low refractive index having a film thickness of 40 nm on the lower layer of low refractive index. In addition, the refractive index of the formed upper layer of low refractive index was 1.42.

In this way, an antireflection laminated body of the present invention was obtained.

### Comparative Example

By the same method as Example 1, a hard coat layer (film thickness 5 μm, refractive index 1.52) was formed on a triacetylcellulose film (TDY80UL, a product of FUJIFILM Corporation:thickness 80 μm, refractive index 1.49) using the coating liquid for forming the hard coat layer. Further, by the same method as Example 1, alkali treatment of the hard coat layer was performed. Then, by the same method as Example 1, a high refractive index layer (film thickness 200 nm, refractive index 1.55) was formed on a surface of the hard coat layer where alkali treatment was performed, by using the coating liquid for forming the hard coat layer.

Next, the coating liquid C for forming the low refractive index layer was applied to the high refractive index layer by a micro gravure method. The liquid C was heated and cured by using an oven of 120° C. for 5 minutes to form a low refractive index layer having a film thickness of 100 nm on the high refractive index layer. In addition, the refractive index of the formed low refractive index layer was 1.36.

In this way, an antireflection laminated body was obtained.

The following characteristics of antireflection laminated bodies in Example 1, 2 and Comparative Example was evaluated.

### 1. Arithmetic Average Roughness

Arithmetic average roughness (Ra) of the antireflection laminated body was calculated by using an atom force microscope (AFM, NanoScopellia, a product of Digital Instruments) where scanning range was 1 μm, and convexes and concaves having height of 0.5 μm or more are eliminated from the measured data as a noise.

### 2. Optical Characteristics

Reflectance: Reflectance of the surface of low refractive index layer of the antireflection laminated body was measured by using a spectrophotometer (U4100, a product of Hitachi High-Technologies Corporation) at 550 nm where incidence angle was 5°.

Haze value and transmittance of all rays of light: Haze value and transmittance of all rays of light of the antireflection laminated body was measured by using an apparatus for measuring an image clarity (NDH-2000, a product of Nippon Denshoku Industries Co., Ltd.)

### 3. Adhering Property

A surface of the low refractive index layer of the antireflection laminated body was evaluated according to “cross cut adhesion test” of JIS-K5400. An antireflection laminated body was fixed to a steel plate. Thereafter a surface of the antireflection laminated body was cut by a cutter to make a slit in a lattice shape. The lattice shape had 100 squares (=10 squares×10 squares). The size of one square was 1 mm×1 mm. A cellophane adhesive tape was attached to the lattice shaped cut part, thereafter the adhesive tape was peeled off and a state where the low refractive index layer and the high refractive index layer was attached to the transparent substrate or not was observed using a microscope. Table 1 shows the result about evaluation of the adhering property. In addition, the adhering property is represented by the number of the residual squares.

### 4. Wiping Off a Fingerprint

A fingerprint was formed on a surface of the low refractive index layer, thereafter the fingerprint was wiped off using a tissue paper. The residual fingerprint was checked by eyes. The result was evaluated by the following marks:

∘: the fingerprint could be easily wiped off;

Δ: the fingerprint could be wiped off; and

×: the fingerprint could not wiped off.

### 5. Abrasion Resistant Test

Surface of the low refractive index layer of an antireflection laminated body was rubbed ten times by reciprocal movement of a steel wool (#0000), where load of 500 g/cm² was applied to the steel wool. A scratch in the surface was checked by eyes. The result was evaluated by the following marks:

⊚: no scratch;

∘: a little scratch;

Δ: many scratch; and

×: too many scratch.

FIG. 1 shows the evaluation result of the antireflection laminated bodies in FIG. 1, 2 and Comparative Example.

TABLE 1

| | | | Comparative |
|---|---|---|---|
| | Example 1 | Example 2 | Example |
| Surface roughness | 2.0 nm | 2.5 nm | 4.6 nm |
| (Ra) | | | |
| Minimum | 0.83% | 1.09% | 1.01% |
| reflectance | | | |
| Haze | 0.15% | 0.16% | 0.15% |
| transmittance | 94.50% | 94.30% | 94.30% |
| Adhering property | 100 | 100 | 100 |
| Antifouling | ◯ | ◯ | ◯ |
| property | | | |
| Abrasion resistant | ⊚ | ⊚ | Δ |
| property | | | |

(The disclosure of Japanese Patent Application No. JP2006-156899, filed on Jun. 6, 2006, is incorporated herein by reference in its entirety.)

What is claimed is:

1. An antireflection laminated body comprising a transparent substrate, a lower layer of low refractive index on the substrate, wherein the lower layer comprises low refractive index particles, and an upper layer of low refractive index on the lower layer, wherein no particle exist in the upper layer.

2. The antireflection laminated body according to claim 1, wherein a refractive index of the lower layer of low refractive index is in the range of 1.28 to 1.42, and the refractive index of the upper layer of low refractive index is in the range of 1.38 to 1.46

3. The antireflection laminated body according to claim 1, wherein the low refractive index particles used in the lower layer of low refractive index have an average particle diameter from 10 nm to 150 nm.

4. The antireflection laminated body according to claim 1, wherein arithmetic surface roughness Ra of a surface side, where the lower layer of low refractive and upper layer of low refractive index are placed, is equal to or less than 2.5 nm.

5. The antireflection laminated body according to claim 1, wherein a total optical thickness of the following A and B, is in the range of 100 nm to 200 nm:
A: an optical thickness obtained by multiplying a film thickness of the lower layer of low refractive index by the refractive index of the lower layer of low refractive index; and
B: an optical thickness obtained by multiplying a film thickness of the upper layer of low refractive index by the refractive index of the upper layer of low refractive index.

6. The antireflection laminated body according to claim 1, wherein a value obtained by dividing a film thickness of the upper layer of low refractive index by a film thickness of the lower layer of low refractive index is in the range of 0.2 to 1.5.

7. The antireflection laminated body according to claim 1, wherein a high refractive index layer comprising conductive particles is formed over the transparent substrate, and the lower layer of low refractive index and the upper layer of low refractive index are formed over the high refractive index layer.

8. A polarizing plate, comprising:
the lower layer of low refractive index and the upper layer of low refractive index being formed on one side of the transparent substrate of the antireflection laminated body according to claim 1; and
a polarizing layer and a second transparent substrate being, in this order, formed on the other side of the transparent substrate of the antireflection laminated body according to claim 1.

9. A polarizing plate comprising:
the transparent substrate, the lower layer of low refractive index and the upper layer of low refractive index according to claim 1 which are disposed on one surface side of a polarizing plate; and
a polarizing layer and a second transparent substrate which are disposed on the opposite surface side of the polarizing plate.

10. A transmission type liquid crystal display comprising the polarizing plate according to claim 8, a liquid crystal cell, a second polarizing plate and a backlight unit, in this order.
